(19) United States
(12) Patent Application Publication
(10) Pub. No.: US 2002/0184612 A1
(43) Pub. Date: Dec. 5, 2002

(54) Runtime configurable caching for component factories

(76) Inventors: Joseph R. Hunt, Loveland, CO (US); Julio Cesar Garcia, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/872,085

(22) Filed: Jun. 1, 2001

(51) Int. Cl. G06F 9/44

(52) U.S. Cl. 717/116

(57) ABSTRACT

A method and structure for allowing object-oriented applications to create and configure caches for the objects used is disclosed. The method and structure use a general purpose cache integrated with object factories that provide the objects used by the application. The object factory can store objects in cache so that application requests for objects are returned in a fast and transparent manner to the calling application. A particular cache may support one or more object factories. The object factory that provides access to a cache is a specialized type of object factory, called a cacheable factory. The cacheable factory contains methods for adding, removing, and accessing objects in the cache associated with the cacheable factory object.

### BACKGROUND OF THE INVENTION

1. TECHNICAL FIELD

The present invention relates generally to object-oriented development of software applications and more specifically to object caching strategies in object-oriented applications.

2. BACKGROUND OF THE INVENTION

Caching strategies are often a part of the software development process when application speed and overhead are important considerations. A caching strategy allows a software application to retrieve frequently used results more quickly by interacting with special memory locations with faster access time than general purpose computer memory. Caching is often done using specialized hardware or at the operating system level. This type of caching is not easily accessible to an object-oriented application. Applications that need higher level caching build their own type-specific caches. The process of building type-specific caches is laborious and can significantly increase the application development overhead. Adding caching for new object types can be difficult, since each new type of object has specific memory and storage requirements that must be met for optimal performance. These criteria make it difficult to obtain a caching strategy that is consistent across many different object types. Caches are an integral part of the application and tuning the cache for optimal performance can have a significant coding impact across the application.

A mechanism that allows object-oriented applications to configure caches for the objects that they use would allow application performance to improve. Applications that manipulate high-level objects need significant control over the caching mechanisms for the objects they manipulate. These caching mechanisms should be different depending upon the type of object that is manipulated. A cache that is integrated with the object creation functionality of an application would minimize the coding impact upon applications wishing to use this caching strategy.

### SUMMARY OF THE INVENTION

It is an object of the invention to integrate configurable caches with object factories.

It is further an object of the invention that a single cache be accessible by more than one object factory.

It is yet another object of the invention that interactions between the cache and the object factories be transparent to the application.

It is another object of the invention that the cache associated with an object factory be configurable during the run-time operation of the application.

It is further an object of the invention that objects stored in a cache have unique identifiers.

It is yet another object of the invention that the cache maintain the status of each object in the cache.

Therefore, according to the method of the present invention, run-time configurable caching of component factories can be achieved. The use of run-time caching allows an object-oriented application to create, populate, and manage object-specific caches while the application is running. The application first creates an object that manages the cache, and sets the size of the cache, and some other parameters. After creating the cache, the application can assign this cache to one or more object factories. Note that a single cache can support more than one object factory. After being assigned to a factory, the factory can add, remove, or find objects stored in the cache.

A special type of object, called a cacheable factory object derived from a factory object, contains the methods to add a cache object to a factory, and obtain a pointer to the current cache object in a factory. Adding a cache to a factory simply entails creating a cache object and adding the cache to a factory. Removing a cache from a factory entails passing a null cache pointer to the factory. A cache can be added to a factory at any time during the life of the application. A cache can also be reconfigured at any time.

A cache factory is used to create the cache objects that provide the interface to the cache. Cache factories create objects whose only function is to contain pointers to generic objects. Because caches can contain generic objects, they can cache objects for any factory. This allows a single cache to support more than one object factory. The only requirement for objects in the cache is that they be given unique identifiers.

After creating a cache and assigning it to a factory, an application request for an object causes the factory object to check the cache first and determine whether the requested object is in its cache. If the object is in the cache, then the factory asks the cache for the requested object. If the object is not in the cache, the factory object interacts with the database to create the requested object. The object is then stored in the cache, and the requested object is returned to the application.

The object-oriented application interacts with the cache through the use of cache objects and cacheable factory objects. The cache object is created by the cache factory object, and subsequently configured by the application.

After configuring the cache object, the application may assign one or more cache factory objects to the cache encapsulated by the cache object. The cache factory objects inherit from a factory object, and interact directly with the application and the cache object to locate, add, remove, or otherwise manipulate objects from the cache.

### BRIEF DESCRIPTION OF THE DRAWINGS

The novel features believed characteristic of the invention are set forth in the claims. The invention itself, however, as well as a preferred mode of use, and further objects and advantages thereof, will best be understood by reference to the following detailed description of an illustrative embodiment when read in conjunction with the accompanying drawings, wherein:

FIG. 1 shows an example of how an application, factory objects, and cache interact, according to the present invention.

FIG. 2 shows a sequence diagram of the object interactions, according to the present invention.

FIG. 3 is a flowchart illustrating how an application interacts with an object factory to obtain an object, according to the present invention.

FIG. 4 is an interface hierarchy diagram, according to the present invention.

### DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawing.

The present invention discloses a method and structure for integration of run-time configurable caches with object factories in an object-oriented application. According to this method, an object-oriented application containing one or more object factories may use one or more caches associated with the one or more object factories in order to provide fast access to objects associated with the application. According to the structure of the present invention, objects are provided which encapsulate the cache from the object-oriented application. These objects contain methods that allow the object-oriented application to manipulate the objects contained in the cache.

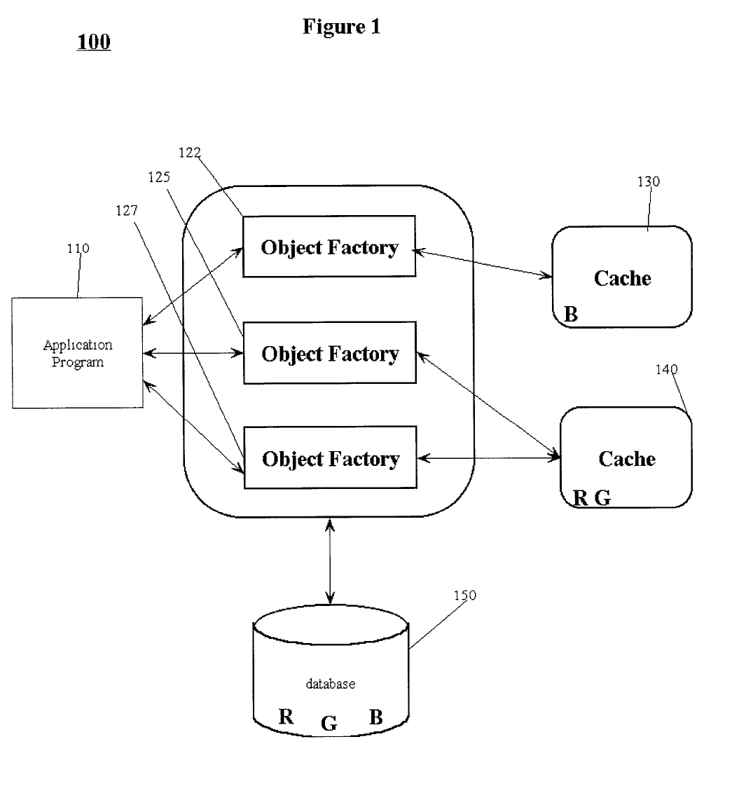

Referring now to FIG. 1, an exemplary architecture 100 of an object-oriented application 110, three object factories, two caches, and a database 150 is shown. For the purposes of this example, the database 150 contains three objects: R, G, and B. Application 110 interacts with object factory 122, object factory 125, and object factory 127, in order to use the R, G, and B objects. The two caches in FIG. 1 are used by the three object factories to store the R, G, and B objects. Cache 130, which interacts with object factory 122, stores the B object. Cache 140, which interacts with object factory 125 and object factory 127, stores the R and G objects. Note that one cache, in this case cache 140, can be associated with more than one object factory. When application 110 requests one of the R, G or B objects, the object factory associated with these objects can retrieve the object directly from the appropriate cache, thereby saving the time required for a database access. For example, if application requests the B object, then object factory 122 interacts with cache 130 to retrieve the B object and return it to application 110. Note that in the preferred embodiment, an object is returned to application 110 by reference, although a copy of the object may be returned without departing from the spirit and scope of the invention.

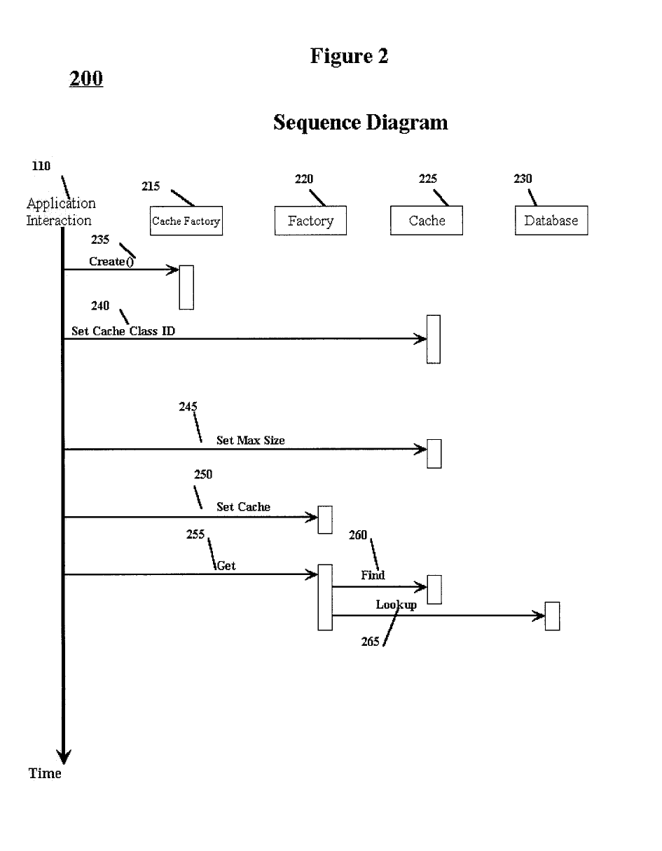

Referring now to FIG. 2, a sequence diagram showing the interaction between the application, factory object, and cache objects is shown. Application 110 first sends a create message 235 to cache factory object 215. Cache factory object 215 creates cache object 225. Cache object 225 may then be configured by application 110. Application 110 sets the Class Cache ID by sending a setClassCacheID message 240 to cache object 225. Application 110 then sends a setMaxSize message 245 to cache object 225 in order to set the size of the created cache object. These commands may be used to configure the cache object for use with various types of objects. Once application 110 has configured cache object 225, application 110 sends a setCache message 250 to a factory object 220, thereby associating factory object 220 with cache object 225. This association allows objects created by factory object 220 to use cache object 225. Factory object 220 can interact with cache object 225 to add objects to the cache, remove objects from the cache, retrieve messages from the cache, or perform other similar types of operations. After application 110 sends the setCache message 250 to factory object 220, application 110 may directly request an object contained in cache object 225 using get message 255. Factory object 220 then sends a find message 260 to cache object 225. If cache object 225 has this object, then the object is returned to application 110. If cache object 225 is not able to find the object in the cache, then factory object 220 sends a lookup message to database object 230. Database object 230 then returns the requested content to factory object 220. Factory object 220 then creates and returns the requested object to application 110. Factory object 220 also stores a copy of the requested object in cache object 225.

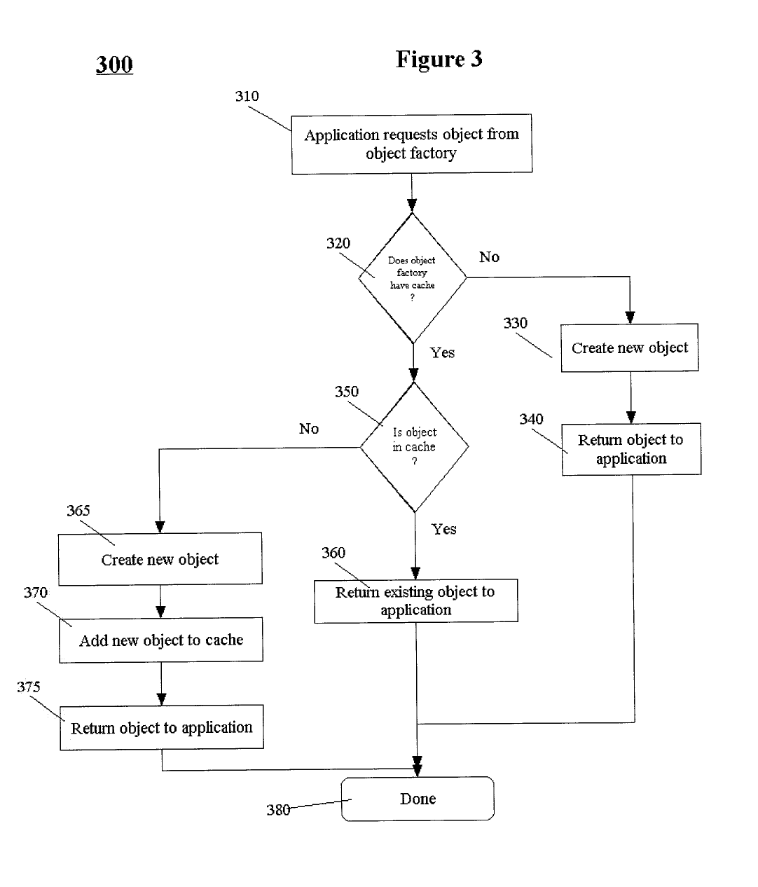

Referring now to FIG. 3, a flowchart 300 of the interaction between application 110 and the factory object 220 is shown. Referring to block 310, application 110 requests an object from factory object 220. If factory object 220 does not have a cache (block 320), then a new object is created (block 330), the object is returned to application 110 (block 340), and the request is completed (block 380). If factory object 220 does have a cache and the object is found in the cache (block 350), then cache object 225 returns the requested object to application 110 (block 360), and the request is completed (block 380). If the object is not found in the cache (block 350), then a new object is created (block 365), added to the cache (block 370), the object is returned to application 110 (block 375), and the request is completed (block 380).

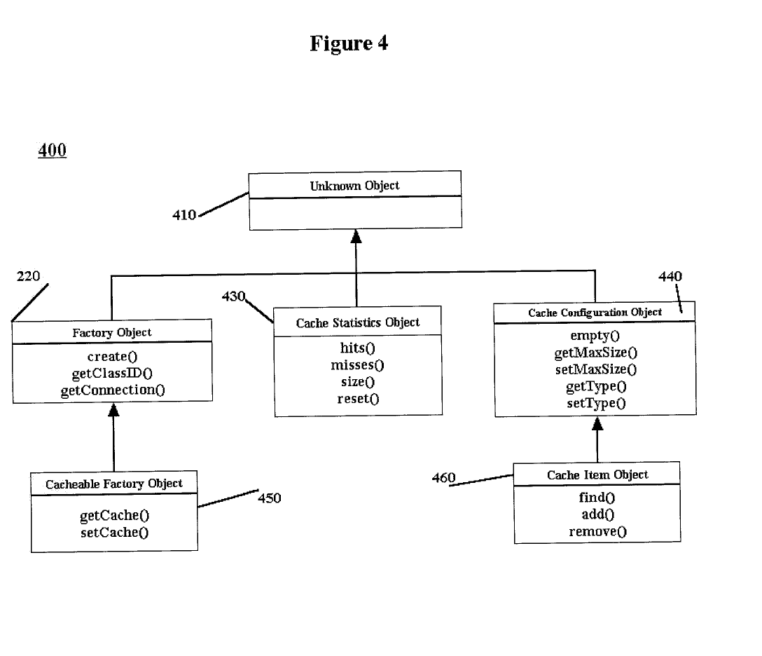

Referring now to FIG. 4, a class hierarchy 400 is shown for the present invention. A generic object 410 is the parent object to factory object 220, cache statistics object 430, and cache configuration object 440. Cache statistics object 430 contains methods for obtaining the hits, misses, cache size, and a reset method. Cache configuration object 440 contains methods for emptying the cache, getting and setting the maximum size, and getting and setting the type of cache object 225. The type of cache object 225 indicates how the cache handles objects that do not match the corresponding object contained in database 150. When an object becomes stale, it may be removed immediately or only marked as stale, depending upon the value of the cache object type obtained using the getType method. A cache item object 460, which derives from cache configuration object 440, contains methods to add an object to the cache, remove an object from the cache, or find an object located in the cache.

The factory object 220 contains methods to create a cache object, get a classID, and get a database connection instance. Factory object 220 inherently couples the created cache object to database 150 through the use of the get database connection instance method. Cacheable factory object 450 derives from factory object 420 and contains methods to set and get the cache associated with factory object 220. It should be noted that in the preferred embodiment of the present invention, other classes may be used to provide enhanced cache management strategy without departing from the spirit and scope of the present invention. It is further noted that the database object 150 may interact with Microsoft® ODBC™, Oracle™, Sybase™, or any database element that has similar operating characteristics.

Thus, in the present invention, a single cache may be coupled to one or more object factories, and therefore coupled to one or more databases, through the use of cache objects, cache factory objects and unique identifiers assigned to each object in the cache. The cache objects and cacheable factory objects interact with the object-oriented application in order to provide a transparent interface between the application, the database and the cache. That is, the application does not need to deal with how objects are retrieved from the cache or stored in the cache. Also, the use of cache objects and cache factory objects encapsulate the cache so that during run-time operation the cache may be manipulated. One aspect of this manipulation is that objects may be added, removed or located within the cache, and these objects can be organized so that the correspondence between the accuracy of these objects relative to the database they came from is established.

While the invention has been particularly shown and described with reference to a preferred embodiment, it will be understood by those skilled in the art that various changes in form and detail may be made therein without departing from the spirit and scope of the invention.

What is claimed is:

1. A method for run-time configurable caching of component factories, comprising:
launching an object-oriented application;
creating and initializing a plurality of cacheable factory objects;
creating and initializing a plurality of cache objects;
assigning one or more cache objects of the plurality of cache objects to one or more cacheable factory objects of the plurality of cacheable factory objects; and
manipulating one or more objects contained in the plurality of cache objects.

2. The method of claim 1, wherein the plurality of cache objects contain a plurality of methods to add an object to a cache, remove an object from the cache, and find an object in the cache.

3. The method of claim 1, wherein the plurality of cacheable factory objects contain a plurality of methods to get an object from a cache, and to couple a cache object to a cacheable factory object.

4. The method of claim 1, wherein the plurality of cacheable factory objects derive from a corresponding plurality of factory objects.

5. The method of claim 4, wherein the plurality of factory objects contain a plurality of methods to create an object, obtain an object identifier, and get a database connection object.

6. The method of claim 4, wherein the plurality of factory objects and the plurality of cache objects derive from a common base object.

7. The method of claim 1, further comprising:
a plurality of cache statistics objects; and
a plurality of cache configuration objects.

8. The method of claim 7, wherein the plurality of cache statistics objects contain a plurality of methods to determine the number of cache accesses, the number of times a cache access returned an empty result, the size of a cache, and a reset command.

9. The method of claim 7, wherein the plurality of cache configuration objects contain a plurality of methods to empty a cache, set and get a maximum cache size, and set and get the cache type.

10. The method of claim 1, wherein initializing the plurality of cache objects, further comprises:
setting a cache type for each cache object of the plurality of cache objects; and
setting a maximum size for the number of objects contained in each cache object of the plurality of cache objects.

11. The method of claim 10, wherein the cache type for each cache object of the plurality of cache objects determines how each object in the cache is removed from the cache.

12. The method of claim 1, wherein the application interacts with the plurality of cacheable factory objects to manipulate the one or more objects located in the plurality of cache objects.

13. The method of claim 12, wherein manipulating the one or more objects further comprises adding one or more objects to the plurality of cache objects.

14. The method of claim 13, wherein adding the one or more objects located in the plurality of cache objects, further comprises:
the application sending a message to a cacheable factory object of the plurality of cacheable factory objects to add the one or more objects to the cache object coupled to the cacheable factory object;
the cacheable factory object receiving the message and sending a message to the cache object to add the one or more objects to the cache coupled to the cache object.

15. The method of claim 12, wherein manipulating the one or more objects further comprises removing one or more objects from the plurality of cache objects.

16. The method of claim 15, wherein removing the one or more objects located in the plurality of cache objects, further comprises:
the application sending a message to a cacheable factory object of the plurality of cacheable factory objects to remove the one or more objects located in a cache object coupled to the cacheable factory object;
the cacheable factory object receiving the message and sending a message to the cache object to remove the one or more objects from the cache coupled to the cache object.

17. The method of claim 16, wherein initializing the plurality of cache objects further comprises:
setting a cache type for each cache object of the plurality of cache objects; and
setting a maximum size for the number of objects contained in each cache object of the plurality of cache objects.

18. The method of claim 17, wherein the cache type for each cache object of the plurality of cache objects determines how each object in the cache is removed from the cache.

19. The method of claim 12, wherein manipulating the one or more objects further comprises locating one or more objects from the plurality of cache objects.

20. The method of claim 19, wherein locating the one or more objects located in the plurality of cache objects, further comprises:
the application sending a message to a cacheable factory object of the plurality of cacheable factory objects to locate the one or more objects located in a cache object coupled to the cacheable factory object;
the cacheable factory object sending a message to the cache object determining whether any of the one or more objects are contained in the cache object;
if able to locate the one or more objects, the cache object returning any of the one or more objects contained in the cache object; and
if unable to locate the one or more objects, the cacheable factory object accessing the one or more objects from a database, and adding the one or more objects to the cache object.

21. The method of claim 12, wherein manipulating the one or more objects further comprises identifying which of the one or more objects contained in the plurality of cache objects are not the same as the corresponding one or more objects contained in a database.

22. A structure for run-time configurable caching of component factories, comprising:
one or more factory objects, coupled to an object-oriented application;
one or more cacheable factory objects, derived from the one or more factory objects; and
one or more cache objects, coupled to the cacheable factory objects.

23. The structure of claim 22, wherein the object-oriented application interacts with the plurality of cacheable factory objects in order to manipulate one or more objects contained in the plurality of cache objects.

24. The structure of claim 22, wherein a plurality of objects contained in the one or more cache objects can be uniquely identified.

25. The structure of claim 22, wherein the plurality of cache objects contain a plurality of methods to add an object to a cache, remove an object from the cache, and find an object in the cache.

26. The structure of claim 22, wherein the plurality of cacheable factory objects contain a plurality of methods to get an object from a cache, and to couple a cache object to a cacheable factory object.

27. The structure of claim 22, wherein the plurality of cacheable factory objects derive from a corresponding plurality of factory objects.

28. The structure of claim 22, wherein the plurality of factory objects contain a plurality of methods to create an object, obtain an object identifier, and get a database connection object.

29. The structure of claim 22, wherein the plurality of factory objects and the plurality of cache objects derive from a common base object.

30. The structure of claim 22, further comprising:
a plurality of cache statistics objects; and
a plurality of cache configuration objects.

31. The structure of claim 30, wherein the plurality of cache statistics objects contain a plurality of methods to determine the number of cache accesses, the number of times a cache access returned an empty result, the size of a cache, and a reset command.

32. The structure of claim 30, wherein the plurality of cache configuration objects contain a plurality of methods to empty a cache, set and get a maximum cache size, and set and get the cache type.

33. The structure of claim 30, wherein the plurality of cache statistics objects and the plurality of cache configuration objects derive from the common base object.
